(19) United States
(12) Patent Application Publication
(10) Pub. No.: US 2013/0024303 A1
(43) Pub. Date: Jan. 24, 2013

(54) PAYMENT PROCESSING SYSTEM AND METHOD

(71) Applicant: Denis Michael Stollery, Glenelg (AU)

(72) Inventor: Denis Michael Stollery, Glenelg (AU)

(73) Assignee: STOLLERY INVESTMENTS NO.2 PTY LIMITED, Walkerville, South Australia (AU)

(21) Appl. No.: 13/520,778

(22) PCT Filed: Dec. 24, 2010
(86) PCT No.: PCT/AU10/01754

§ 371 Date: Sep. 24, 2012

(30) Foreign Application Priority Data
Jan. 6, 2010 (AU) 2010900039

(51) Int. Cl. G06Q 20/20; G06Q 20/40

(52) U.S. Cl. 705/16; 705/44

(57) ABSTRACT

A method for effecting payment for goods or services provided by a supplier comprising • providing a centralised payment controller (CPC); • conducting a transaction between a supplier of goods or services and a purchaser of those goods or services; • communicating transaction data from the point of the sale to the CPC; • in accordance with the data provided to the CPC, the CPC then arranging for funds to be provided by a funding entity, either directly or via the CPC, to the supplier, those funds corresponding to the supplier's invoice minus any relevant fees or changes; and • the CPC arranging for the purchaser to make payment(s) to the funding entity, either directly or via the CPC, over an agreed period of time, the payment(s) corresponding to the supplier's invoice plus any relevant fees or charges payable to the funding entity or the CPC.

### TECHNICAL FIELD

This invention relates to the processing of payments, such as payment of accounts or invoices or payments for purchases. These payments may be for the supply of goods or services, or for any approved account, invoice, purchase or debt that is owed by an approved buyer/debtor and requires payment.

### BACKGROUND TO THE INVENTION

There are many examples of payment processing systems and methods for ensuring that a supplier of goods or services to a purchaser of those goods or services can receive immediate or accelerated payment via a credit arrangement, even though the purchaser of the goods or services may be intending to make payments over an extended period or in the future. For example, the arrangement may be directly between the bank, financial institution or funding organisation and the purchaser, with the bank, financial institution or funding organisation providing credit (funds) to the purchaser. Alternatively, the arrangement may be that the bank, financial institution or funding organisation provides the credit arrangement indirectly to the purchaser, via the supplier of the goods or services. In the latter case, the purchaser will be contracting with the supplier of the goods or services, rather than the bank/financial institution/funding organisation itself, for access to extended payment terms.

For example, U.S. Pat. No. 6,267,282, entitled “Method and apparatus for funds and credit line transfers”, relates to a financial tender transfer system which allows a transferor to transfer credit or make payment to a transferee by debiting the credit card of the transferor and crediting the credit card of the transferee. The financial tender transfer system gives the transferee immediate access to the transferred money and ensures the transferor's credit card is valid. Neither party needs to give their credit card number to the other, so security is preserved. Any amount of value up to the full credit line of the transferor can be transferred to the transferee.

### SUMMARY OF THE INVENTION

The present invention relates to a system and method whereby a centralised payment controller (the “Accelerated Bill Payment controller” or the “ABP”) facilitates provision of funds by a funding entity or “External Funder” for immediate or early payment, under instruction from the ABP, to a creditor (the “Seller”) which is owed payment by a debtor (the “Buyer”) approved by the ABP. The transaction between the Seller and the Buyer may, for example, relate to the supply of goods or services by a supplier (the “Seller”) to an approved purchaser of those goods or services (the “Buyer”). Once the relevant contractual agreement (for example, between the ABP and the Buyer) is established, the ABP, under instruction from the Buyer, provides a service to the Buyer which is to make immediate or early (“accelerated”) payments to the Seller, either directly or via the ABP, for goods or services supplied by the Seller to the Buyer, or for any other debt owed by the Buyer to the Seller. The funding entity or “External Funder” can either be the ABF itself or an independent funding entity such as a bank or other financial institution or funding organisation. Once the ABP or the External Funder has completed the service to the Buyer and accelerated the payment to the Seller, the Buyer then makes corresponding payment to the ABP or the External Funder, either directly or via the ABP, according to the terms of the agreement between the ABP and the Buyer.

For example, the agreement between the Buyer and the ABP may allow for extended or deferred terms of payment to the ABP or the External Funder, subject to a fee or charge payable by the Buyer to the ABP or the External Funder, that fee or charge being as defined by the ABP in the contract or agreement between the Buyer and the ABP.

The ABP may offer this payment processing system and method to any Buyer which is approved by the ABP.

In a first aspect of the present invention, a method for effecting payment for goods or services provided by a supplier (the Seller) comprises:
providing a centralised payment controller (the “Accelerated Bill Payment controller” or “ABP”);
conducting a transaction between a supplier of goods or services (the “Seller”) and a purchaser of those goods or services (the “Buyer”);
communicating data indicative of the transaction from the point of sale to the centralised payment controller (the “Accelerated Bill Payment controller” or the “ABP”);

in accordance with the data provided to the centralised payment controller (the “Accelerated Bill Payment controller” or the “ABP”), the ABP then arranging for funds to be provided by a funding entity (the “External Funder”), either directly or via ABP, to the supplier of goods or services (the “Seller”), those funds corresponding to the Seller's invoice for the goods or services supplied minus any relevant fees or charges; and
the ABP arranging for the Buyer to make payments) to the funding entity (the “External Funder”), either directly or via the ABP, over an agreed period of time, the payment(s) to the External Funder or the ABP corresponding to the total value of the Seller's invoice to the Buyer for goods or services supplied plus any relevant fees or charges payable to the External Funder or the ABP pursuant to an agreement between the Buyer and the ABP.

In a second aspect of the present invention, a method for effecting payment for a debt owed by a debtor to a creditor comprises:
providing a centralised payment controller (the “Accelerated Bill Payment controller” or the “ABP”);
conducting a transaction between the creditor and the debtor resulting in an obligation for payment by the debtor to the creditor;
communicating data indicative of the transaction to the centralised payment controller (the “Accelerated Bill Payment controller” or the “ABP”);
in accordance with the data provided to the centralised payment controller (the “Accelerated Bill Payment controller” or the “ABP”), the ABP then arranging for funds to be provided by a funding entity (the “External Funder”), either directly or via the ABP, to the creditor, those funds corresponding to the creditor's invoice for the transaction minus any relevant fees or charges; and
the ABP arranging for the debtor to make payment(s) to the External Funder, either directly or via the ABP, over an agreed period of time, the payment(s) to the External Funder or the ABP corresponding to the creditor's invoice for the relevant transaction plus any relevant fees or charges.

In a third aspect of the present invention, a system for effecting payment for goods or services provided by a supplier (the “Seller”) comprises:
a centralised payment controller (the “Accelerated BUI Payment controller” or the “ABP”) for administering and processing transactions between a supplier of goods or services (the “Seller”) and a purchaser of those goods or services (the “Buyer”), that Buyer having been approved by the ABP;
the centralised payment controller (the “Accelerated Bill Payment controller” or the “ABP”) receiving data indicative of the transactions, which is communicated from the point of sale to the centralised payment controller (the “Accelerated Bill Payment controller” or the “ABP”);
a funding entity, under the direction of the centralised payment controller (the “Accelerated Bill Payment controller” or the “ABP”) and in accordance with the data provided to the centralised payment controller (the “Accelerated Bill Payment controller” or the “ABP”), providing funds, either directly or via the ABP, to the supplier of goods or services (the “Seller”) to the approved Buyer, those funds corresponding to the Seller's Invoice for the goods or services supplied minus any relevant fees or charges; and
the Buyer, under the direction of the centralised payment controller (the “Accelerated Bill Payment controller” or the “ABP”), making payment(s) to the funding entity, either directly or via the ABP, over an agreed period of time, the payment(s) from the Buyer to the funding entity or the ABP corresponding to the Seller's invoice for goods or services supplied plus any relevant fees or charges.

In a fourth aspect of the present invention, a system for effecting payment for a debt owed by a debtor to a creditor comprises:
a centralised payment controller (the “Accelerated Bill Payment controller” or the “ABP”) for administering and processing transactions between the creditor and the debtor resulting in an obligation for payment by the debtor to the creditor, that debtor having been approved by the centralised payment controller;
the centralised payment controller (the “Accelerated Bill Payment controller” or the “ABP”) receiving data indicative of the transactions;
a funding entity, under the direction of the centralised payment controller (the “Accelerated Bill Payment controller” or the “ABP”) and in accordance with the data provided to the centralised payment controller (the “Accelerated Bill Payment controller” or the “ABP”), providing funds, either directly or via the ABP, to the creditor, those funds corresponding to the creditor's invoice for the relevant transaction minus any relevant fees or charges; and
the debtor, under the direction of the centralised payment controller (the “Accelerated Bill Payment controller” or the “ABP”), making payment(s) to the funding entity, either directly or via the ABP, over an agreed period of time, the payment(s) corresponding to the creditor's invoice to the approved debtor for the relevant transaction plus any relevant fees or charges.

### BRIEF DESCRIPTION OF THE DRAWINGS

FIG. 1 is a diagram Illustrating a first embodiment of the payment processing system and method of the present invention, in which funding is provided by a funding entity such as a financial institution or other funding organisation (the “External Funder”) to the ABP, the ABP then providing a service to the Buyer, in which the Buyer instructs the ABP to accelerate a payment to a Seller, with the ABP facilitating immediate or early (“accelerated”) payment to the Seller. The Buyer then makes payment, on agreed terms, to the ABP for the service that the ABP has provided to the Buyer.

FIG. 2 is a diagram illustrating a second embodiment of the payment processing system and method of the present invention in which, under the direction of the centralised payment controller (the “Accelerated Bill Payment controller” or “ABP”), funding is provided directly by a funding entity such as a financial institution or other funding organisation (the “External Funder”) to the Buyer, and the Buyer makes payments directly to the External Funder for the service that the External Funder provides to the Buyer.

### DETAILED DESCRIPTION OF VARIOUS EMBODIMENTS OF THE INVENTION

The payment processing system and method will now be described in terms of preferred embodiments, which are illustrative, but not restrictive, of the present invention.

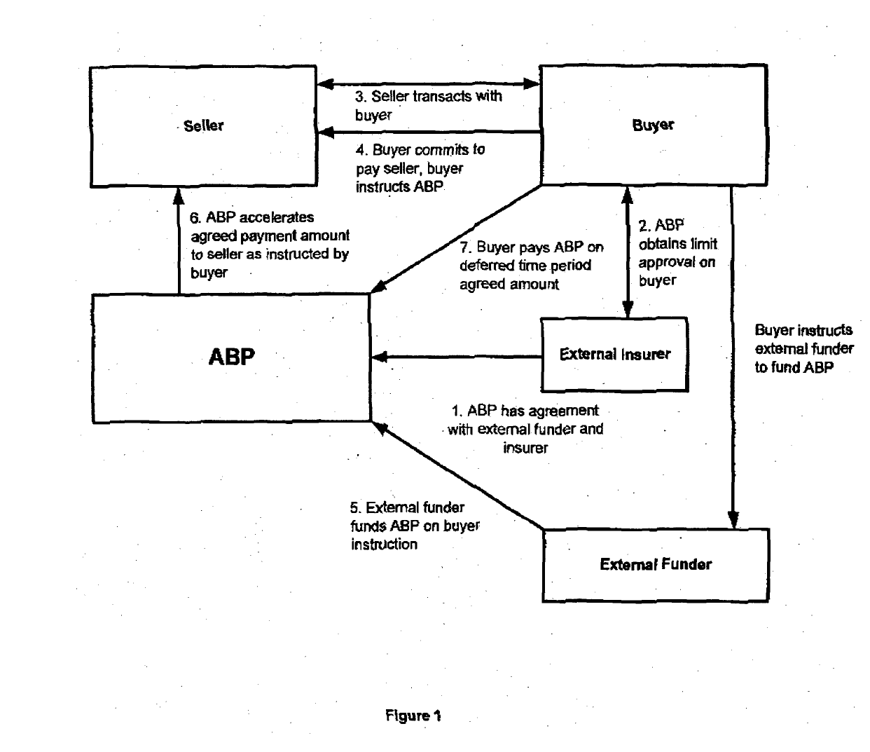

In a first embodiment, as illustrated in FIG. 1, the centralised payment controller (the “Accelerated Bill Payment controller” or “ABP”) contracts with the Buyer to provide payments, under instruction from the Buyer, to a specified Seller. The payments are for goods or services, for approved debts, or for amounts owed by the Buyer to sellers or other parties, such as payments for purchase of assets, purchase of property, staff salaries, commissions, or shareholder dividends, to name but a few examples.

Pursuant to the contract between the ABP and the Buyer, the Buyer instructs the ABP to make early (accelerated) payments to the specified Seller for amounts owed by the Buyer to the Seller. The ABP or the External Funder will attend to the Buyer's instruction and make early (accelerated) payments to the Seller on behalf of the Buyer. Funding for the payments is provided either by the ABP or by an independent funding entity, such as a bank, financial institution or other funding organisation (the “External Funder”). The ABP or the External Funder will make payment using its own funds and, in most cases, will be insured against the risk of lace or a default payment or lack of payment by the Buyer.

This payment processing system and method means that the ABP and the External Funder bear no responsibility for the risk of financial loss, and generally are insured against liability for fraud by the Buyer, or late repayments or non-repayment by the Buyer of the amount owed to the Seller.

In this embodiment, neither the ABP nor the External Funder, in providing a facility (the “approved Buyer Facility”) to the Buyer for making early (accelerated) payment to a Seller, is ever directly or indirecty involved with, nor has any contractual agreement with, the Seller.

In this embodiment, the ABP, acting under instructions from the Buyer, may approach one or more of the Sellers supplying goods or services to the Buyer to offer this early (accelerated) payment system (the “approved Buyer Facility”) to the Seller(s), whereby the Sellers) can obtain early (accelerated) payment of all invoices for purchase of approved items (goods or services) which are delivered to and accepted by the Buyer.

If a Seller agrees to this approved Buyer Facility being offered by the ABP, the Seller is then listed as being an approved Seller, and the Buyer may then instruct the ABP to issue the Seller with a Transaction Card, which is provided and administered by the ABP and which has the Seller's and the Buyer's information encoded therein (e.g. by means of an electronic chip). The encoded Transaction Card can incorporate any relevant information, such as Seller details, which Buyers have been approved by the Seller for this early (accelerated) payment system, a summary of prior transactions between the Seller and a particular Buyer, and current External Funder fees relevant to transactions between the Seller and the Buyer.

Prior to, at the time of, or after the Seller has made delivery of goods or services to the Buyer, details of that transaction, including the Seller's invoice details, will be entered on the Transaction Card. This can be done, for example, by swiping the Transaction Card through a terminal located at the Seller's place of business, or by any method approved by the ABP.

Preferably, the Buyer will be supplied by the ABP with a similar Transaction Card which may, for example, be called an Authorisation or Summary Card, where the details of any relevant transaction can be entered or approved by the Buyer, for example, by swiping the Transaction Card through a terminal located at the Buyer's place of business. The Buyer can then, if they so wish, obtain a regular (for example, dally or weekly) summary of transactions between the Seller and the Buyer from the information encoded in the Transaction Card. The Buyer can then either accept or decline any of these transactions for payment via the early (accelerated) payment system facilitated by the ABP. If a transaction is accepted by the Buyer, this will trigger the early (accelerated) payment from the ABP to the Seller. Normally, the Seller will pay the Buyer a fee for this service, so the early (accelerated) payment to the Seller will be for the full amount of the Seller's invoice to the Buyer, minus that agreed fee, which fee (or part thereof) is paid to the ABP by the Buyer.

The ABP, having completed the early (accelerated) payment to the Seller, will then debit the Buyer's nominated bank account, on an agreed deferred date, with the amount that the ABP requires as payment from the Buyer for the service that ABP has provided to the Buyer in relation to this transaction. For example, there may be a charge to be paid by the Buyer to the ABP for each new transaction, which may be defined in the contract between the Buyer and the ABP as a “new payment obligation amount”.

According to the terms of the contract between the ABP and the Buyer, the Buyer then, over the extended payment period provided by the contract, pays the ABP the agreed amount, which will generally be the full amount of the Seller's invoices plus any fees or charges payable to the ABP. Payment may be by direct debit from the Buyer's nominated bank account, in which case the ABP will only be permitted to direct debit that account for amounts owed by the Buyer to the ABP for the services provided by ABP to the Buyer, which debt amount is called a “new payment obligation amount”.

An approved Seller may, for example, by way of notice to the Buyer, from time to time request to vary the timing of the Buyer's early (accelerated) payment to the Seller. If payment would normally be made within a week, the Seller may instead be able to request more urgent payment (such as overnight) or later payment (such as within one or two months), with the fees to be paid by the Seller to the Buyer being commensurate with the urgency of payment The fees to be paid by the Seller to the Buyer will be deducted from the face value of the Seller's invoice (for supply of goods or services to the Buyer) before the corresponding early (accelerated) payment is made (under instruction from the Buyer) by the ABP to the Seller.

Once a Seller is accepting early (accelerated) payment under an approved Buyer Facility system, the Seller can request, either via the approved Buyer or direct to the ABP, that the ABP approve other Buyer companies that the Seller regularly supplies with goods or services. If the ABP approves those other Buyer companies, those Buyers will establish a similar relationship with the ABP, thus allowing the Seller to supply those Buyers with goods or services and receive payment by means of the same early (accelerated) payment system facilitated by the ABP. If an approved Seller does supply more than one approved Buyer and obtains payment by means of the Transaction Card, then the Seller's fees relating to that Transaction Card could be shared between the various Buyer and ABP partnerships.

Preferably, the ABP and/or External Funder will have a website or an electronic process/portal that will provide relevant information about the ABP's early (accelerated) payment system, and any approved Seller at any time will be able to search that website to ascertain if other companies that the Seller supplies with goods or services are approved Buyers and, if they are, register as a Seller with respect to those companies and, if not, request that the companies be approved as Buyers. A Seller (either approved or not approved) can request that the ABP approve a Buyer and provide a credit limit (the “Facility Limit”) on that Buyer. Also, a Seller, on completing a Tender or Quote for supply to a Buyer, can obtain information from the ABP on the Buyer to see if the Buyer is an approved Buyer with the ABP and, if not, request that the ABP contract the Buyer as an approved Buyer from the details provided.

The Buyer can obtain an increase in the amount to be covered by the early or accelerated payments (the “Facility Limit”) with the ABP or the External Funder by way of a request to increase the Facility Limit.

The service provided by ABP (the “Facility”) does not normally require the Buyer or Seller to pay any application fees or costs, and the only fee that the ABP or the External Funder requires to be paid by the Buyer in the embodiment shown in FIG. 1 is the “new payment obligation amount” that is owed by the Buyer to the ABP.

Both the External Funder and the ABP are able to hedge the credit payment default risk by outsourcing the default payment risk of the ABP or the Buyer respectively to an insurer, such as an S&P (Standard & Poor's) Rated Debtor Protection underwriter.

The External Funder and the External Insurer, as shown in FIG. 1, can either be separate entities or the same company. Also, there can be more than one External Funder and more than one External Insurer.

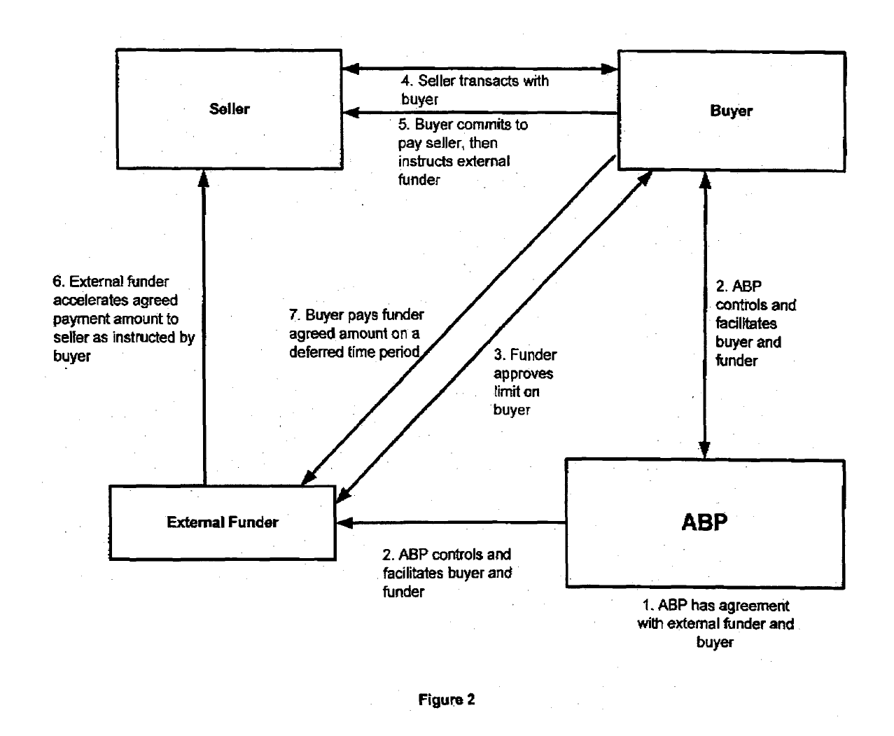

In a second embodiment, as illustrated in FIG. 2, a similar payment processing system and method is provided, but with the External Funder providing a service directly (rather than via the ABP) to the Buyer in which the External Funder, under instruction from the Buyer, accelerates payments to an approved Seller, and the Buyer makes payment for the service provided directly (rather than via the ABP) to the External Funder. The overall administration of the payment processing system and method is still provided by the ABP which, in the embodiment shown in FIG. 2, has a contractual relationship with the Buyer, which pays the ABP's fees or charges for providing the early (accelerated) payment Facility to the Buyer.

In the case of the embodiment shown in FIG. 2, the ABP and the External Funder will charge a fee for the service provided to the Buyer pursuant to the terms of the Faculty Agreement between the Buyer, the ABP and the External Funder. In this embodiment, the External Funder has no contractual arrangement with the Seller.

The early (accelerated) payment system of the present invention is particularly advantageous if a Buyer is transacting with Sellers in other countries, in that payment is immediate, so that neither party will risk financial loss through changes in exchange rates between the time of the transaction and the time of payment.

A further development of the early (accelerated) payment system of the present invention is that an approved Buyer with an ABP Facility can become a Seller to another approved Buyer, or an approved Seller to an approved Buyer can become an approved Buyer and in that way allow for sellers to that Buyer (which had previously itself been an approved Seller) to obtain accelerated payments.

In order to facilitate better understanding of the invention, the present invention has been described in terms of preferred embodiments, and with regard to the particular elements and/or features described or depicted therein. It should however be appreciated that various modifications can be made without departing from the principles of the invention. Therefore, the invention should be understood to include all such modifications within its scope.

For example, the Buyer, with the consent and formal approval of the ABP, may instruct the ABP to accelerate payments of the Buyer's accounts for matters other than the supply of goods or services by a Seller. In particular, the early (accelerated) payment system may (subject to the ABP's approval and consent) be utilised by the Buyer for such matters as payment of staff salaries, Government tax payments, dividend payments to shareholders, payments to landlords, payment of commissions, or purchase of cars, buildings or property. In these examples, the Buyer would seek approval from the ABP for payment of amounts that are not related to services or delivery of goods. In these instances, the fees or charges payable to the ABP and/or External Funder for providing the early (accelerated) payment would be met by the Buyer.

1. A method for effecting payment for goods or services provided by a supplier comprising:
a. providing a centralized payment controller;
b. conducting a transaction between a supplier of goods or services and a purchaser of those goods or services;
c. communicating data indicative of the transaction from the point of sale to the centralized payment controller;
d. in accordance with the data provided to the centralized payment controller, the centralized payment controller determining whether the supplier of goods or services has been approved by the purchaser as an approved supplier to the purchaser, then either rejecting the transaction, or if the supplier is approved, arranging for funds to be provided by a funding entity, either directly or via the centralized payment controller, to the approved supplier, those funds corresponding to the approved supplier's invoice for the goods or services supplied; and
c. the centralized payment controller arranging for the purchaser to make payment(s) to funding entity, either directly or via the centralized payment controller, over an agreed period of time, the payment(s) to the funding entity or the centralized payment controller corresponding to the approved supplier's invoice for goods or services supplied plus any relevant fees or charges payable to the funding entity or the centralized payment controller pursuant to an agreement between the purchaser and the centralized payment controller.

2. A method for effecting payment for a debt owed by a debtor to a creditor comprising:
a. providing a centralized payment controller;
b. conducting a transaction between the creditor and the debtor resulting in an obligation for payment by the debtor to the creditor;
c. communicating data indicative of the transaction to the centralized payment controller;
d. in accordance with the data provided to the centralized payment controller, the centralized payment controller determining whether the creditor has been approved by the debtor as an approved creditor to the debtor then either rejecting the transaction or if the creditor is approved arranging for funds to be provided by a funding entity, either directly or via the centralized payment controller, to the approved creditor, those funds corresponding to the approved creditor's invoice for the transaction; and
e. the centralized payment controller arranging for the debtor to make payment(s) to the funding entity, either directly or via the centralized payment controller, over an agreed period of time, the payment(s) to the funding entity or the centralized payment controller corresponding to the approved creditor's invoice for the relevant transaction plus any relevant fees or charges.

3. The method according to claim 1, wherein the funds are provided by the funding entity, via the centralized payment controller, to the approved supplier of goods or services.

4. The method according to claim 2, wherein the funds are provided by the funding entity, via the centralized payment controller, to the approved creditor.

5. The method according to claim 1, wherein the purchaser or the debtor makes payments, via the centralized payment controller, to the funding entity.

6. The method according to claim 1, wherein the funds are provided directly by the funding entity to the approved supplier of goods or services.

7. The method according to claim 2, wherein the funds provided directly by the funding entity to the approved creditor.

8. The method according to claim 1, wherein the purchaser or the debtor makes payments directly to the funding entity.

9. The method according to claim 1, wherein the centralized payment controller is also the funding entity.

10. A system for effecting payment for goods or services provided by a supplier approved by a purchaser of those goods or services comprising:
a. a centralized payment controller for administering and processing transactions between the approved supplier of goods or services and the purchaser of those goods or services, that purchaser having been approved by the centralized payment controller;
b. the centralized payment controller receiving data indicative of the transactions, which is communicated from the point of sale to the centralized payment controller;
c. the centralized payment controller processing the received data and determining whether the supplier associated with the point of sale is an approved supplier to the purchaser, and
i. the central payment controller rejecting the transaction if the supplier is not an approved supplier; or
ii. if the supplier is approved the centralized payment controller instructing a funding entity in accordance with the data provided to the centralized payment controller, providing funds, either directly or via the centralized payment controller, to the approved supplier of goods or services, those funds corresponding to the approved supplier's invoice for the goods or services supplied; and
iii. the approved purchaser, under the direction of the centralized payment controller, making payment(s) to the funding entity, either directly or via the centralized payment controller, over an agreed period of time, the payment(s) from the approved purchaser to the funding entity or the centralized payment controller corresponding to the approved supplier's invoice for goods or services supplied plus any relevant fees or charges.

11. A system for effecting payment for a debt owed by a debtor to a creditor approved by the debtor, comprising:
a. a centralized payment controller for administering and processing transactions between the approved creditor and the debtor resulting in an obligation for payment by the debtor to the approved creditor, that debtor having been approved by the centralized payment controller;
b. the centralized payment controller receiving data indicative of the transactions;
c. the centralized payment controller processing the receive data and determining whether the supplier associated with the point of sale is an approved supplier to the purchaser, and
i. the central payment controller rejecting the transaction if the supplier is not an approved supplier; or
ii. if the supplier is approved the centralized payment controller instructing a funding entity in accordance with the data provided to the centralized payment controller, providing funds, either directly or via the centralized payment controller, to the approved creditor, those funds corresponding to the approved creditor's invoice for the relevant transaction; and
iii. the debtor, under the direction of the centralized payment controller, making payment(s) to the funding entity, either directly or via the centralized payment controller, over an agreed period of time, the payment(s) corresponding to the creditor's invoice to the approved debtor for the relevant transaction plus any relevant fees or charges.

12. The system according to claim 10, wherein the funds are provided by the funding entity, via the centralized payment controller, to the approved supplier of goods or services.

13. The system according to claim 11, wherein the funds are provided by the funding entity, via the centralized payment controller, to the approved creditor.

14. The system according to claim 10, wherein the purchaser or the debtor makes payments, via the centralized payment controller, to the funding entity.

15. The system according to claim 10, wherein the funds are provided directly by the funding entity to the approved supplier of goods or services.

16. The system according to claim 11, wherein the funds are provided directly by the funding entity to the approved creditor.

17. The system according to claim 10, wherein the purchaser or the debtor makes payments directly to the funding entity.

18. The system according to claim 10, wherein the centralized payment controller is also the funding entity.

19. The method according to claim 1, substantially as described herein and with reference to either of FIGS. 1 and 2.

20. The system according to claim 10, substantially as described herein and with reference to either of FIGS. 1 and 2.
